(19) United States
(12) Patent Application Publication
(10) Pub. No.: US 2014/0075319 A1
(43) Pub. Date: Mar. 13, 2014

(54) ESTABLISHING CLOUD SERVER IN CLIENT DEVICE

(71) Applicant: Jenke Wu Kuo, San Diego, CA (US)

(72) Inventor: Jenke Wu Kuo, San Diego, CA (US)

(73) Assignee: SONY CORPORATION

(21) Appl. No.: 13/610,149

(22) Filed: Sep. 11, 2012

(51) Int. Cl. G06F 15/173; G06F 15/16; G06F 3/01

(52) U.S. Cl. 715/736; 709/225; 709/204

(57) ABSTRACT

Client devices of, e.g., social networking friends can elect to form their own local cloud network for sourcing Internet cloud services to each other. One or more client devices may be configured as a cloud server, downloading from the Internet cloud services it requires or other devices in the local cloud require, to source the services locally. A user may be given the option of trying to access cloud services first through the Internet, and then through the local cloud if the Internet is unavailable, to ensure the most updated service is available, or trying to access cloud services first through the local cloud and then through the Internet if the service is not available locally.

### I. FIELD OF THE INVENTION

The present application relates generally to establishing cloud server functionality in client devices.

### II. BACKGROUND OF THE INVENTION

The growth of modern web technology has spawned ubiquitous cloud computing services which provide plentiful applications to home and mobile CE devices. It has formed a solid ecosystem based on the concept of being application oriented to promote user convenience when employing one or more of the plentiful smart mobile devices (e.g. smart phone, tablet computers, personal computers, etc.) on the market.

With the abundant cloud services today, users enjoy applications as a client with cloud services on various portable devices. As understood herein, however, cloud services may not be available from time to time. As also understood herein, some web applications do not require Internet consistently, but only need to obtain and store certain resource from a cloud server occasionally.

### SUMMARY OF THE INVENTION

Accordingly, a portable device can be an agent for cloud services to service dedicated APIs from its local cache storage data. The local cloud service in the portable device can also be implemented as the agent of cloud service infrastructure and it may cache the service resource and information to share with other devices.

A client device includes at least one processor that is configured to access instructions on at least one computer readable storage medium to cause the processor to establish, along with at least one other user device, a local cloud network. The processor also executes at least one application requiring access to a cloud service and determines whether a user of the client device has selected to attempt to access the local cloud network in preference to accessing the Internet to obtain the cloud service. The processor of the client device attempts to access at least one other device in the local cloud network in response to determination that the user of the client device has selected to attempt to access the local cloud network in preference to accessing the Internet. The processor may also avail the client device of the cloud service by sourcing the cloud service through the local cloud network in response to a determination that the local cloud network can provide the cloud service. Alternatively, the processor may avail the client device of the cloud service by attempting to source the cloud service through the Internet in response to a determination that the local cloud network cannot provide the cloud service. The processor of the client device may attempt to access the cloud service through the Internet in response to a determination that the user has not selected to attempt to access the local cloud network in preference to accessing the Internet. The processor of the client device can avail the client device of the cloud service by sourcing the cloud service through the Internet in response to a determination that the Internet is available to the client device and can provide the cloud service. The processor of the client device may otherwise avail the client device of the cloud service by attempting to source the cloud service through the local cloud network in response to a determination that the Internet is not available to the client device.

The processor of the client device can control a display to present a user interface (UI) to permit a user to establish members of the local cloud network. The client device may automatically populate the UI with a list of contacts from at least one social network address book in the client device. The UI can subsequently prompt the user to accept each contact on the list desired by the user to be in the local cloud network and can permit the user to select whether to have cloud services pushed to the client device automatically or not push cloud services to the user unless the user first pulls the services.

The client device can exchange cloud service requirements with the user device over the local cloud network. The processor can control a display to present a user interface (UI) to permit a user to select whether to access cloud services by first trying to access cloud services through the Internet or through the local cloud network.

In another aspect, a system includes plural client computing devices and a local cloud network established by the client computing devices for sourcing Internet cloud services to each other. One or more client computing devices in the local cloud network can be configured as an Internet cloud server and may download from the Internet cloud services it requires or other devices in the local cloud network require, to source the services locally.

In another aspect, a method includes configuration of plural client devices of social networking friends to enable users of the client devices to form a local cloud network for sourcing Internet cloud services to each other. One or more client devices is configured as a cloud server, downloading from the Internet cloud services it requires or other devices in the local cloud require. The method also includes the use of the cloud server to source the services locally in the local cloud network.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system according to present principles;

FIG. 2 is a flow chart of example local cloud service set up logic;

FIG. 3 is a screen shot of an example user interface on a client device display for setting up local cloud services;

FIG. 4 is a flow chart of example logic for populating the local cloud network;

FIG. 5 is a screen shot of an example user interface on a client device display for establishing where the local device preferentially seeks cloud services; and

FIG. 6 is a flow chart of example logic for executing local cloud service.

### DETAILED DESCRIPTION OF THE PREFERRED EMBODIMENT

Referring initially to FIG. 1, a system is shown, generally designated 10, in which one or more client devices 12, 14, 16 access cloud services hosted by one or more Internet server 18 through the Internet 20. In the example shown, a local cloud network 22 is established by the client devices 12, 14, 16, it being understood that present principles apply to any number of client devices.

As shown, the Internet server 18 typically includes one or more processors 24 accessing one or more computer readable storage media 26 to provide cloud services, including gaming services, widgets, social networking services, and the like to the client devices. The client devices, which may be implemented by smart phones, game consoles, tablet computers, personal computers, and other smart consumer electronic (CE) devices, likewise include their own local processors and storage media. Taking the client device 12 as an example, the client device 12 includes one or more processors 28 accessing one or more computer readable storage media 30 such as disk-based or solid state storage. The processor 28 typically receives input from one or more input devices 32 such as touch screen sensors underlying a video display 34 controlled by the processor, mice, keypads, keyboards, game console controls, voice input (microphones), etc.

The processor 28 may communicate with the Internet 20 using an Internet interface 36 such as a wired or wireless modem such as a WiFi transceiver, or a wireless telephony transceiver such as a global systems for mobile communications (GSM) transceiver or variants thereof, or a code division multiple access (CDMA) transceiver or variants thereof, or an orthogonal frequency division multiplexed (OFDM) transceiver or variants thereof, etc. Additionally, the processor 28 may include a short range local area network (LAN) interface 38 such as a Bluetooth or near field communication (NFC) transceiver. The client device 14 is substantially identical in its salient configurations as the client device 12, as is the client device 16 with the exception that the client device 16 has no Internet interface, but only a LAN interface as shown.

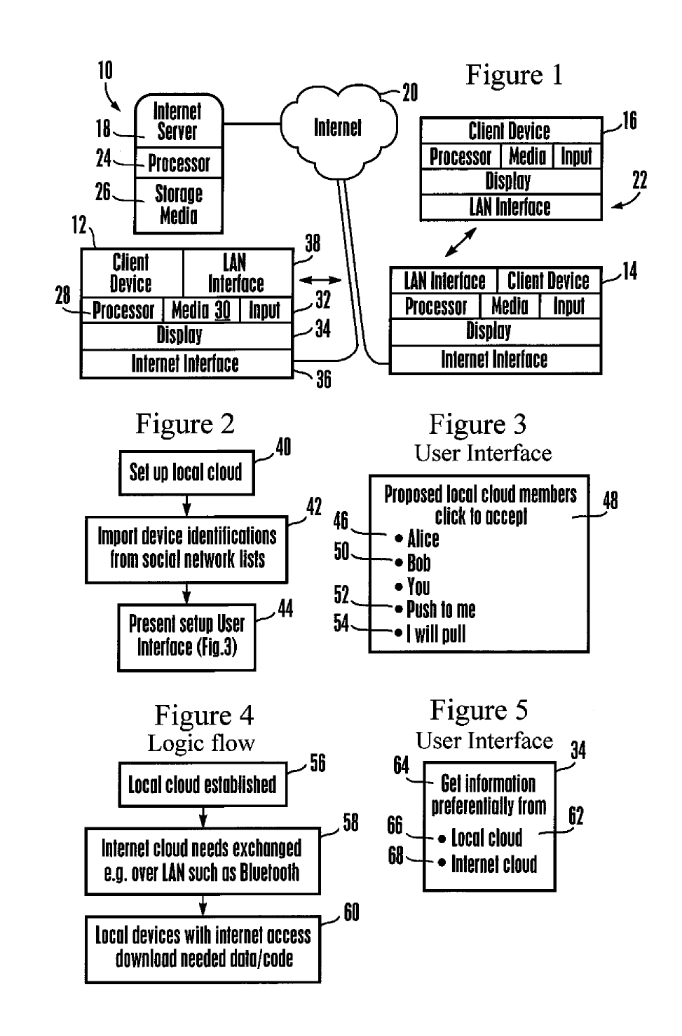

Moving in reference to FIG. 2, example logic for setup of local cloud service is shown and begins with the establishment of the local cloud network 22 at block 40 by the processor 28 of the client device 12. The processor 28 establishes the local cloud network 22 with at least one other user device. The processor 28 executes at least one application requiring access to a cloud service and sources at least one local cloud service through the local cloud network 22 or through the Internet 20 if the local cloud network 22 is not available or if user preferences direct the processor to utilize the Internet 20 rather than the local cloud network 22. Use of the local cloud network 22 is preferred over the Internet 20 due to decreased delay of information exchange in the local cloud network 22. The processor 28 imports device IDs from social network address lists at block 42 and presents a set up UI on the display 34 at block 44.

Now referring to FIG. 3, a screen shot of an example UI 46 on a client device display 34 for setting up local cloud services includes a menu title 48, a contact list 50, and push/pull cloud service options 52,54. The user of the client device 12 establishes members of the local cloud network 22 based on the contact list 50, which includes contacts from at least one social network address book in the storage media 30 of client device 12 or stored on an online social networking site. The UI 46 prompts to user of client device 12 to accept each contact on the list 50 desired by the user to be in the local cloud network 22. The UI 46 also permits the user to select whether to have cloud services pushed 52 to the client device automatically or not push 54 cloud services to the user unless the user first pulls the services

FIG. 4 demonstrates the logic for populating a local cloud network 22. The local cloud network 22 is established at block 56 and the client device 12 exchanges cloud service requirements with the user device over the local cloud network 22 at block 58. Local devices that have Internet access then download the needed data and/or code at block 60.

The screen shot in FIG. 5 of an example user interface 62 on a client device display 34 includes a prompt 64 for establishing where the local device preferentially seeks cloud services. The user responds to the cloud service source prompt 64 by making either a local cloud selection 66 or an Internet cloud selection 68.

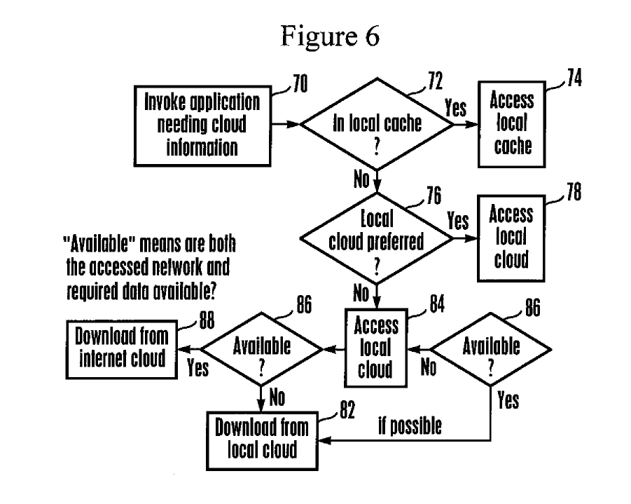

Moving in reference to FIG. 6, the logic for the execution of local cloud service begins with the processor 28 invoking an application that needs cloud information at block 70. The processor 28 determines whether the cloud information is stored in the local cache 30 of the client device 12 at decision diamond 72. Confirmation of storage of cloud information in the local cache 30 results in the processor 28 accessing the local cache at block 74, thereby terminating the flow of logic for the execution of local cloud service.

The absence of cloud information storage in the local cache 30 directs the processor 28 to determine whether a local cloud is preferred at decision diamond 76. If a local cloud is preferred in accordance with the user's preselected setting (as in FIG. 5), the processor 28 will attempt to access the local cloud at block 78. Availability of the local cloud is determined by the processor 28 at decision diamond 80 and, when available, cloud information is subsequently downloaded from the local cloud at block 82.

“Available” in this instance as well as those that follow refers to both the accessed network and the required data being available. If access to the local cloud is not available at decision diamond 80 or if the local cloud is not preferred in accordance with the user's preselected setting (as in FIG. 5) at decision diamond 76, then the processor 28 will attempt to access the Internet cloud at block 84. Availability of the Internet cloud is determined by the processor 28 at decision diamond 86 and cloud information is downloaded from the Internet cloud at block 88 if access to the Internet cloud is determined to be available. Unavailability of the Internet cloud directs the processor 28 to download cloud information from the local cloud, if available, at block 82.

It may now be appreciated that the local cloud network 22 can be promoted as a public cloud service to other devices through wired or wireless network connections with the same web application or new applications through the APIs of the cloud service. For example, a user of client device may play a web gaming application in the portable client device that is resident in the local cloud network with other users through network connections with or without Internet access. Also, a client device acting as a local server can be prompted to activate independently to serve multiple web applications concurrently and it also can serve across multiple devices through local network connections without going through internet access. Thus, from the end user perspective, the designed web application can operate anytime by going through the private cloud service by means of the user's client device without the limitation of the internet connection. Also some of internet connections and cloud services may be costly to access, and the local cloud service may help to reduce the time of accessing the public cloud service through the internet as well. Web developers are encouraged to prompt and enhance their applications for additional features with the local cloud service resident in a device by applying original and additional APIs. In some use cases, the local cloud service may backup, filter and block private data and information dissemination to the public Internet protect personal privacy and enhance the security of the device. Thus, a client device can be implemented as a security server for the web applications to the public cloud services. Viewed from a user benefit standpoint, the privacy of cloud service in the portable device may help to save the necessary database and filter out some of unnecessary internet access traffic and block spam or spyware for personal information as well.

In addition to the above, the personal cloud service may provide the process of authentication and authorization for client access with the caching cloud data. The mobile device holding the cloud service may service the social network sharing with authorized people or devices by configuring authorization of this personal cloud service. Note that in some embodiments, the authentication may apply security protection to synchronize the personal cloud service in the mobile device with public cloud services. The storage and cache data in the personal cloud server of the mobile device may apply encryption protection methodologies to synchronize with private data storing in public cloud services. For example, the personal (private) cloud service in the mobile device can be the security key holder to encrypt and protect the personal data for storage thereof in the public cloud so that access to such information in the public cloud may be availed only by going through the personal cloud, which holds the encryption key.

While the particular ESTABLISHING CLOUD SERVER IN CLIENT DEVICE is herein shown and described in detail, it is to be understood that the subject matter which is encompassed by the present invention is limited only by the claims.

What is claimed is:

1. A client device, comprising:
at least one processor configured to access instructions on at least one computer readable storage medium to cause the processor to:
establish, along with at least one other user device, a local cloud network;
execute at least one application requiring access to a cloud service;
determine whether a user of the client device has selected to attempt to access the local cloud network in preference to accessing the Internet to obtain the cloud service;
responsive to a determination that the user of the client device has selected to attempt to access the local cloud network in preference to accessing the Internet, attempt to access at least one other device in the local cloud network;
responsive to a determination that the local cloud network can provide the cloud service, avail the client device of the cloud service by sourcing the cloud service through the local cloud network;
responsive to a determination that the local cloud network cannot provide the cloud service, avail the client device of the cloud service by attempting to source the cloud service through the Internet;
responsive to a determination that the user has not selected to attempt to access the local cloud network in preference to accessing the Internet, attempt to access the cloud service through the Internet;
responsive to a determination that the Internet is available to the client device and can provide the cloud service, avail the client device of the cloud service by sourcing the cloud service through the Internet; and
responsive to a determination that the Internet is not available to the client device, avail the client device of the cloud service by attempting to source the cloud service through the local cloud network.

2. The client device of claim 1, wherein the processor controls a display to present a user interface (UI) to permit a user to establish members of the local cloud network.

3. The client device of claim 2, wherein the client device automatically populates the UI with a list of contacts from at least one social network address book in the client device.

4. The client device of claim 3, wherein the UI prompts the user to accept each contact on the list desired by the user to be in the local cloud network.

5. The client device of claim 3, wherein the UI permits the user to select whether to have cloud services pushed to the client device automatically or not push cloud services to the user unless the user first pulls the services.

6. The client device of claim 1, wherein the client device exchanges cloud service requirements with the user device over the local cloud network.

7. The client device of claim 1, wherein the processor controls a display to present a user interface (UI) to permit a user to select whether to access cloud services by first trying to access cloud services through the Internet or through the local cloud network.

8. A system comprising:
plural client computing devices; and
a local cloud network established by the client computing devices for sourcing Internet cloud services to each other, wherein one or more client computing devices in the local cloud network is configured as an Internet cloud server, downloading from the Internet cloud services it requires or other devices in the local cloud network require, to source the services locally.

9. The system of claim 8, wherein the client computing devices are associated with users who are friends with each other on a social network.

10. The system of claim 8, wherein a user of a client computing device in the local cloud network is given an option of trying to access cloud services first through the Internet, and then through the local cloud network if the Internet is unavailable, to ensure a most updated service is available, or trying to access cloud services first through the local cloud network and only then through the Internet if the service is not available in the local cloud network.

11. The system of claim 8, wherein client computing device presents a user interface (UI) to permit a user to establish members of the local cloud network.

12. The system of claim 11, wherein the client computing device automatically populates the UI with a list of contacts from at least one social network address book in the client computing device.

13. The system of claim 12, wherein the UI prompts the user to accept each contact on the list desired by the user to be in the local cloud network.

14. The system of claim 12, wherein the UI permits the user to select whether to have cloud services pushed to the client computing device automatically or not push cloud services to the user unless the user first pulls the services.

15. The system of claim 8, wherein the client computing device presents a user interface (UI) to permit a user to select whether to access cloud services by first trying to access cloud services through the Internet or through the local cloud network.

16. A method, comprising:
configuring plural client devices of social networking friends to enable users of the client devices to form a local cloud network for sourcing Internet cloud services to each other, wherein one or more client devices is configured as a cloud server, downloading from the Internet cloud services it requires or other devices in the local cloud require; and
using the cloud server to source the services locally in the local cloud network.

17. The method of claim 16, further comprising:
using a client device, providing a user-selectable option of trying to access cloud services first through the Internet, and then through the local cloud network if the Internet is unavailable, or trying to access cloud services first through the local cloud network and then through the Internet if the service is not available in the local cloud network.

18. The method of claim 16, comprising presenting a user interface (UI) to permit a user to establish members of the local cloud network.

19. The method of claim 18, comprising automatically populating the UI with a list of contacts from at least one social network address book in a client device.

20. The method of claim 19, comprising presenting a prompt to accept each contact on the list desired by the user to be in the local cloud network.
